(19) United States
(12) Patent Application Publication
(10) Pub. No.: US 2018/0197116 A1
(43) Pub. Date: Jul. 12, 2018

(54) SYSTEMS AND METHODS FOR CONTROLLING, MONITORING AND AUTOMATING ELECTRONIC DEVICES, AND SYSTEMS AND METHODS FOR GENERATING USER INTERFACES TO CONTROL, MONITOR, AND AUTOMATE ELECTRONIC DEVICES

(71) Applicant: Barco, Inc., Duluth, GA (US)

(72) Inventors: Alex M. Carru, Miami, FL (US); David Rouchet, Montreal, Quebec (CA); Kim Bui, Nanterre (FR)

(73) Assignee: Barco, Inc., Duluth, GA (US)

(21) Appl. No.: 15/741,887

(22) PCT Filed: Jul. 8, 2016
(86) PCT No.: PCT/US2016/041513

§ 371 Date: Jan. 4, 2018

Related U.S. Application Data
(60) Provisional application No. 62/190,477, filed on Jul. 9, 2015.

(51) Int. Cl. G06Q 10/02

(52) U.S. Cl. CPC G06Q 10/02; G06F 3/0481

(57) ABSTRACT

A system for controlling, monitoring and automating electronic devices comprises a control server that includes a hardware processor configured to centrally control the electronic devices. One of the electronic devices is located at a first location among several locations, and another one of the electronic devices is located at a second location that is separate from the first location. The hardware processor is further configured to interface with a room-booking software program configured to consider the first and second locations as separate rooms and to create room-booking information relating to the first location. The hardware processor is further configured to read the room-booking information, and automatically adjust power and/or settings of the electronic devices for a scheduled use of the electronic devices by a user, based on the room-booking information

### CROSS-REFERENCE TO RELATED APPLICATION

This application is a non-provisional application claiming the benefits of U.S. Provisional Patent Application Ser. No. 62/190,477 filed on Jul. 9, 2015, the content of which is hereby incorporated by reference.

### FIELD

The present disclosure relates to the processing of data for controlling, monitoring and automating electronic devices and for and for generating user interfaces to control, monitor, and automate electronic devices, particularly meeting room equipment.

### BACKGROUND

Conventional solutions for controlling audiovisual devices and other electronic devices are overwhelmingly hardware-based. Specifically, conventional control solutions rely on proprietary hardware controllers that are expensive to install and maintain, typically remain powered 24 hours a day, and constitute multiple potential points of failure. In addition, reserving a meeting room using conventional room-hooking systems typically requires multiple hardware controllers (i.e., at least one hardware controller per room) to contact a reservation service. Transferring a scheduled use from one room to another also cannot be automatized using conventional methods.

Moreover, conventional solutions for creating user interfaces to control audiovisual devices and other electronic devices use proprietary programming languages, which is typically difficult to learn for users. In addition, these conventional solutions do not provide adequate and secure user access control.

### SUMMARY

The present disclosure provides a description of systems and methods for controlling, monitoring and automating electronic devices, and systems and methods for generating user interfaces to control, monitor, and automate electronic devices.

A system for controlling, monitoring and automating electronic devices comprises a control server that includes a hardware processor, the electronic devices: including one or more first electronic devices and one or more second electronic devices. The one or more first electronic devices are located at a first location among a plurality of locations, and the one or more second electronic devices are located at a second location among the plurality of locations. The second location is separate from the first location. The hardware processor Is configured to centrally control the plurality of electronic devices. The hardware processor Is further configured to interface with a room-booking software program that is configured to consider the first and second locations as separate rooms and to create room-booking Information relating to the first location. The hardware processor is further configured to react the room-booking information, and automatically adjust power and/or a setting of the one or more first electronic devices located at the first location for a scheduled use of the one or more first electronic devices by a user; based on the room-booking information.

A method for controlling, monitoring and automating electronic devices includes obtaining centralcontrol of the electronic devices, the electronic devices including one or more first electronic devices and one or more second electronic devices. The one or more first electronic devices are located at a first location among a plurality of locations, and the one or more second electronic devices are located at a second location among the plurality of locations. The second location is separate, from the first location. The method further includes interfacing with a room-booking software program configured to consider the first and second locations as separate rooms and to create room-booking information relating to the first location, reading the room-booking information, and automatically adjusting power and/or a setting of the one or more first electronic devices located at the first location for a scheduled use of the one or more first electronic devices by a user, based on the room-booking information.

A system for generating graphical user interfaces for controlling, monitoring and automating a plurality of electronic devices centrally controlled by a control server, the electronic devices Including one or more first electronic devices and one or more second electronic devices. The one or more first electronic devices are located at a first location among a plurality of locations, and the one or more second electronic devices are located at a second location among the plurality of locations. The second location Is separate from the first location. The system comprises a user experience server that Includes a hardware processor. The hardware processor is configured to categorize by type and location, in an information database, the electronic devices. The hardware processor is further configured to automatically generate graphical user interfaces for a help desk, a mobile device, and an in-room control panel using information from the infrastructure database, dynamically based on information in the information database about at least one of the first and second electronic devices to be controlled by a user and about credentials associated with the user. A mobile device can include, but is not limited to, a mobile phone, a tablet computer, a smart watch, or a laptop computer.

A method for generating graphical user interfaces for controlling, monitoring and automating electronic devices centrally controlled by a control server, the electronic devices including one or more first electronic devices and one or more second electronic devices. The one or more first electronic devices are located at a first location among a plurality of locations, and the one or more second electronic devices are located at a second location among the plurality of locations. The second location is separate from the first location. The method comprises categorizing by type and location, in an information database, the electronic devices, and automatically generating graphical user interfaces for a help desk, a mobile device, and an in-room control panel using information from the infrastructure database, dynamically based on information in the information database about at least one of the first and second electronic devices to be controlled by a user and about credentials associated with the user.

### BRIEF DESCRIPTION OF THE DRAWING FIGURES

The scope of the present disclosure is best understood from the following detailed description of illustrative embodiments when read in conjunction with the accompanying drawings. Included in the drawings are the following figures:

FIG. 1 is a block diagram illustrative of a system for controlling, monitoring and automating electronic devices in accordance with illustrative embodiments;

FIG. 2 is a block diagram illustrating a method for controlling, monitoring and automating electronic devices in accordance with illustrative embodiments;

FIG. 3 is a block diagram illustrative of a method for generating: graphical user interfaces for controlling, monitoring and automating a plurality of electronic devices in accordance with illustrative embodiments;

FIG. 4 is a block diagram showing an architecture in accordance with illustrative embodiments;

FIG. 5 is a block diagram showing an architecture in accordance with illustrative embodiments:

FIG. 8 is a block diagram showing an architecture in accordance with illustrative embodiments;

FIG. 7 is a block diagram showing an architecture in accordance with illustrative embodiments;

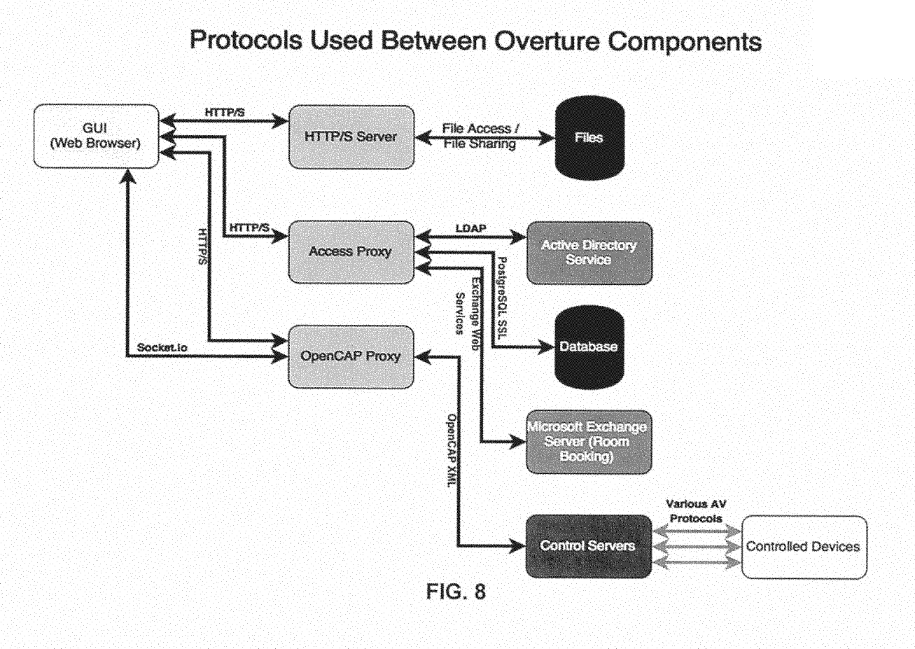

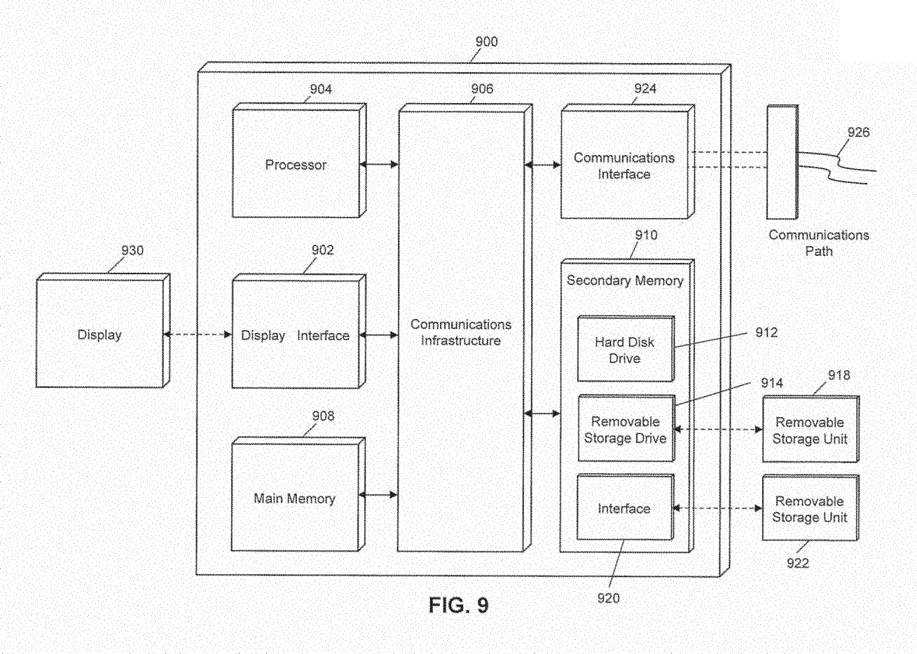

FIG. 8 is a block diagram showing protocols used between components in accordance with illustrative embodiments; and

FIG. 9 is a block diagram showing a computer system architecture in accordance with illustrative embodiments.

Further areas of applicability of the present disclosure will become apparent from the detailed description provided hereinafter. It should be understood that the detailed description of illustrative embodiments are intended for illustration purposes only and are, therefore, not intended to necessarily limit the scope of the disclosure.

### DETAILED DESCRIPTION

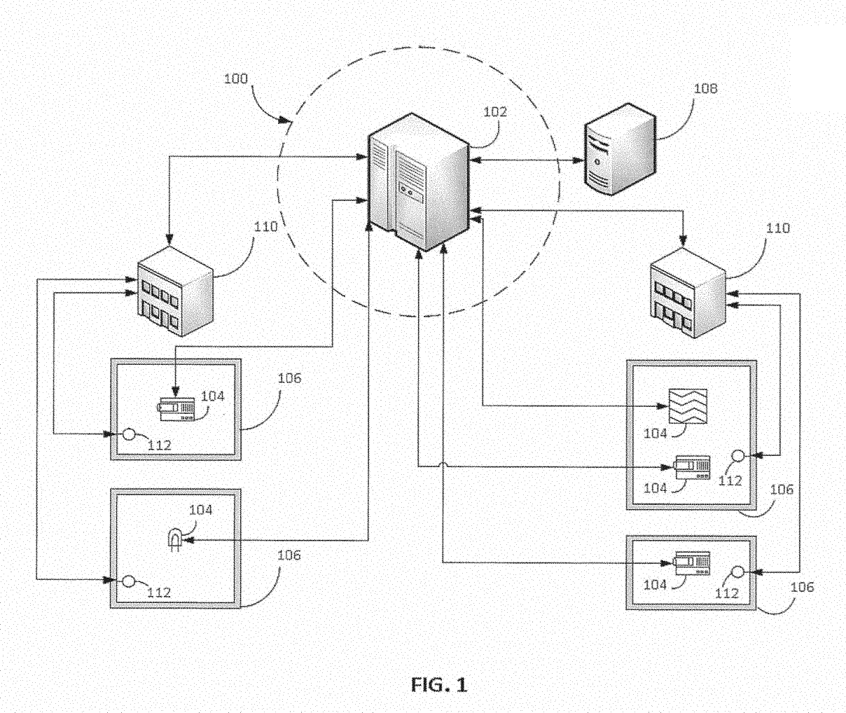

FIG. 1 shows a block diagram of an illustrative system 100 for controlling, monitoring and automating electronic devices 104 in accordance with illustrative embodiments. The system 100 comprises a control sewer 102 that includes a hardware processor.

Arrows in the block diagram depicted in FIG. 1 indicate communication between various elements. Although these arrows are depicted as double-pointing arrows, communication between various elements in some illustrative embodiments includes two-way communication, and communication between various elements in other illustrative embodiments includes both one-way and two-way communication.

In illustrative embodiments, the electronic devices 104 include devices that are controllable electronically and/or electrically.

Illustrative embodiments, electronic devices 104 Includes meeting room equipment, including, but not limited to, lights, projectors, speakers, heating, ventilation and air conditioning (HVAC) devices, window blinds, and other equipment suitable for a meeting room.

Illustrative embodiments, the hardware processor is configured to centrally control the electronic devices 104. The electronic devices 104 can be located at separate locations 108. For example, the electronic devices 104 can be located at separate first and second locations 106.

In illustrative embodiments, a location 106 is a room among rooms across one or more buildings.

In Illustrative embodiments, the hardware processor is configured to interface with a room-booking software program. The room-booking software program is a program configured to consider the first and second locations 106 as separate rooms and to create room-booking information relating to the first location 106. Room-booking information can include, but is not limited to, information about types of electronic devices required for a scheduled use; a hooking schedule of a location 106, whether a location 106 is available for use, a booking schedule of an electronic devices whether an electronic device in a location 106 is available for use, the power status (i.e. ON/OFF) of an electronic device in a location 106, available settings of an electronic device, and current settings of an electronic device. For example, room-booking information is created when a user books a meeting using the room-booking software program. Room-booking interfacing allows the hardware processor to provide information about what equipment is available in the room for a scheduled use, and allows the hardware processor to prepare the room before a meeting and ensure that ail equipment is working.

In illustrative embodiments, the hardware processor is configured to read the room-booking information. In illustrative embodiments, the information is read from a database.

In Illustrative embodiments, the hardware processor is configured to automatically adjust power and/or settings of one or more of the electronic devices 104 located at the first location 106 for a scheduled use of the electronic devices 104 by a user, based on the room-booking information, so as to automatically configure these electronic devices 104. For example, the hardware processor turns on devices and ensures these devices are in proper order, and the hardware processor further sets internal configurations of the devices to ensure they are able to communicate with other devices. In illustrative embodiments, this configuration includes setting protocols to be used between the control server 102 and the electronic devices 104, and between electronic devices 104. For example, in video conferencing applications, devices that normally use different protocols are configured to be able to communicate with one another.

Whereas conventional systems for controlling electronic devices situated in various rooms require hardware controllers in every room, illustrative embodiments of a system 100 of the present disclosure centrally control electronic devices across multiple rooms and/or buildings, interface with a room-booking software program, and automatically adjust power and/or settings of the electronic devices based on room-booking information created by the room-booking software program. As a result, an improved system 100 for controlling electronic devices according to the present disclosure uses less power, is less costly to deploy and maintain, and is scalable (to control electronic devices in any number of rooms across any number of buildings) compared to conventional systems.

In illustrative embodiments, a room-booking software program includes MICROSOFT ENTERPRISE MOBILITY SUITE (EMS), MICROSOFT EXCHANGE, MICROSOFT AZURE, and/or any other suitable room-booking software program.

In illustrative embodiments, room-hooking Information is stored on the control server 102.

In illustrative embodiments, the room-booking information is stored on a room-booking server 108 separate from the control server 102 and in communication with the control server 102.

In illustrative embodiments, the hardware processor is configured to automatically configure one or more of the electronic devices 104 prior to a scheduled time for the scheduled use. In illustrative embodiments, the scheduled time for the scheduled use is contained in the room-hooking information.

In illustrative embodiments, the hardware processor is configured to interface with a building management system 110 to monitor occupancy sensors 112 located at one or more locations 106. In illustrative embodiments, a building management system 110 is associated with one building and the locations 106 in which the occupancy sensors 112 monitored by the building management system 110 are located are rooms of this building.

In illustrative embodiments, communication between the control server 102 and the building management system 110 is by way of common industrial protocols, such as, but not limited to, the Building Automation and Control Networks protocol (BACNET).

In illustrative embodiments, the hardware processor is configured to detect that the scheduled use has ended and/or to detect that one of the locations 106 is vacant.

In illustrative embodiments, the hardware processor is configured to detect that the scheduled use has not occurred.

In illustrative embodiments, the hardware processor is configured to turn off and/or adjust one or more electronic devices 104 when the hardware processor detects that a location 108 is vacant (e.g., when the location 108 of the electronic device 104 to be tuned off or adjusted is vacant). For example, in an illustrative embodiment the hardware processor is configured to turn off audiovisual equipment in a vacant room and adjust an HVAC system so as to use less power.

In illustrative embodiments, the hardware processor is configured to determine a power consumption value associated with at least one electronic device 104, and is further configured to automatically shot down this or these electronic device(s) 104 when the power consumption value is greater than a predetermined threshold power consumption value.

In Illustrative embodiments, the predetermined threshold power consumption value is stored on the control server 102.

In illustrative embodiments, the hardware processor is configured to collect usage information about the electronic devices 104. In illustrative embodiments, usage information Includes, but Is not limited to, the amount of time of usage, the amount of time while turned ON, the amount of time not used, and/or the number of failures over a time period.

In Illustrative embodiments, a usage log is stored, for example, on the control server 102.

In Illustrative embodiments, the control server 102 interfaces with network management protocols, such as the Simple Network Management Protocol (SNMP).

In illustrative embodiments, the hardware processor is configured to determine a usage value associated with an electronic device 104, and is further configured to generate an alert when the power consumption value is greater than a predetermined threshold usage value. This alert can be displayed to a user at the first location 106, and/or can be communicated to an off-site user, such as, but not limited to, as help desk user. This alert can Include visual elements, auditory elements, tactile elements, and/or other elements suitable for an alert.

In illustrative embodiments, the alert is automatically sent to technical staff. In illustrative embodiments, an alert can also be generated when an error associated with one of the electronic devices 104 is detected.

In illustrative embodiments, because all usage data is collected in one system, the hardware processor determines the amount of usage associated with each device and/or location. For example, if the meeting rooms on the second floor of a building are often booked, but the meeting rooms on the fifth floor are often empty, usage statistics will reveal this trend. As a result, devices can be serviced according to their actual use, not just according to scheduled service.

In illustrative embodiments, the centralized aspects of the system allows for electronic devices 104 to be automatically powered on or off based on a fixed schedule, based on room booking information from a room-booking software program, and/or based on data from in-room occupancy sensors 112. Rooms can be automatically configured, setting the air conditioning, powering on the display, and setting up the audio routing automatically before, a scheduled videoconference. When the meeting is over, the audiovisual equipment in a room can be turned off or put into a power-saving mode. In addition, transferring a meeting from one room to another can be automatized. Because the hardware processor of the control server in illustrative embodiments centrally control the plurality of electronic devices, transferring a meeting from a first room to a second room can be automatized by finding a second room that is similar and with similar equipment, and determining whether the equipment is functional and appropriate for a particular event. Information about the transfer and the second room is then sent to attendees.

In illustrative embodiments, the room-booking information includes information about types of electronic devices required for the scheduled use. The hardware processor is configured to determine that the one or more second electronic devices 104 located at the second location match the required types of electronic devices 104, and automatically transfer the scheduled use from the first location to the second location by automatically adjusting power and/or settings of the one or more second electronic devices 104 located at the second location based on the room-booking information. The hardware processor is configured to automatically send a communication to the user notifying the user of the transfer to the second location.

In Illustrative embodiments, the hardware processor is configured to determine that the one or more second electronic devices 104 located at the second location (i) do not match the required types of electronic devices and/or (ii) are unusable for the scheduled use. Electronic devices 104 may be unusable if they are out of order or defective, or if they are scheduled to be operated during another scheduled use at the time of the scheduled use. The hardware processor is configured to determine that one or more third electronic devices 104 located at a third location match the required types of electronic devices, and automatically transfer the scheduled use from the first location to the third location by automatically adjusting power and/or settings of the one or more third electronic devices 104 located at the third location based on the room-booking information.

In illustrative embodiments, energy can be saved by automatically turning off devices when they are not being used. This also improves the useful life of the equipment.

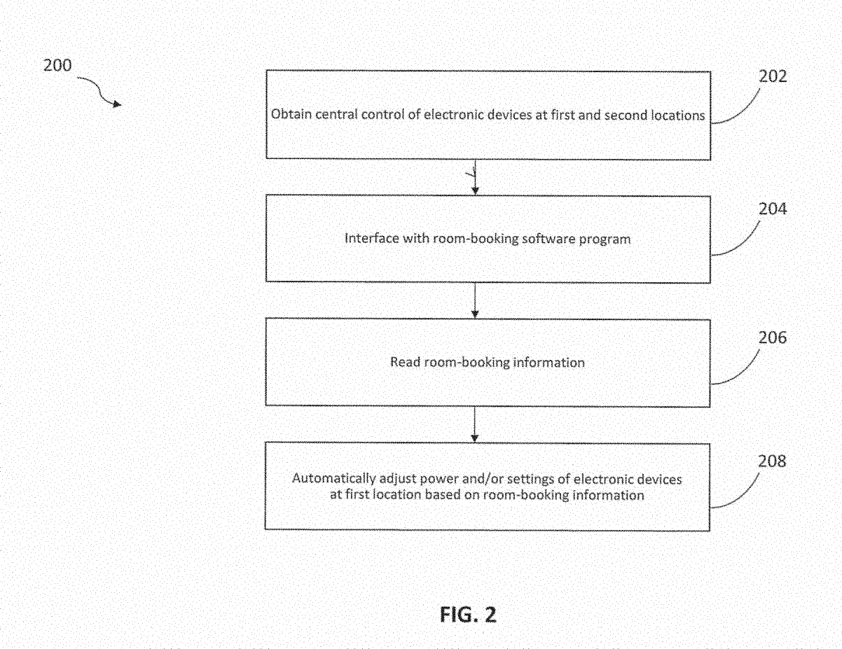

FIG. 2 shows a block diagram of an illustrative method 200 for controlling, monitoring and automating electronic devices 104 in accordance with illustrative embodiments. The method 200 includes obtaining central control of the electronic devices at step 202. The electronic devices 104 can be located at separate first and second locations 106. The method 200 includes interfacing with a room-booking software program at step 204. The room-hooking software program is a program configured to consider the first and second locations 106 as separate rooms and to create room-booking information. The method 200 further includes reading the room-booking information at step 206, and automatically adjusting power and/or settings of the electronic devices 104 for a scheduled use of the electronic devices 104 by a user by a user by a user, based on the room-booking Information, at step 208. Accordingly, the electronic devices 104 are automatically configured.

In illustrative embodiments, additional steps of the method 200 include functions performed by the hardware processor in the system 100 for controlling, monitoring and automating electronic devices 104 described above.

In illustrative embodiments, the automatic configuring of electronic devices 104 is performed prior to a scheduled time for the scheduled use.

In illustrative embodiments, the method 200 comprises interfacing with a building management system to 110 monitor at least one occupancy sensor 112 located at the first location 108.

In Illustrative embodiments, the method 200 comprises detecting that the scheduled use has ended and/or detecting that the first location 108 is vacant.

In illustrative embodiments, the method 200 comprises detecting that the scheduled use has not occurred.

In illustrative embodiments, the method 200 comprises turning off and/or adjusting at least one of the electronic devices 104 when detecting that the first location 106 is vacant.

In illustrative embodiments, the method 200 comprises determining a power consumption value associated with at least one of the electronic devices 104, and automatically shutting down this or these electronic device(s) 104 when the power consumption value is greater than a predetermined threshold power consumption value.

In Illustrative embodiments, the method 200 comprises collecting usage information about the electronic devices 104.

In illustrative embodiments, the method 200 comprises determining a usage value associated with at least one of the electronic devices 104, and generating an alert when the power consumption value is greater than a predetermined threshold usage value.

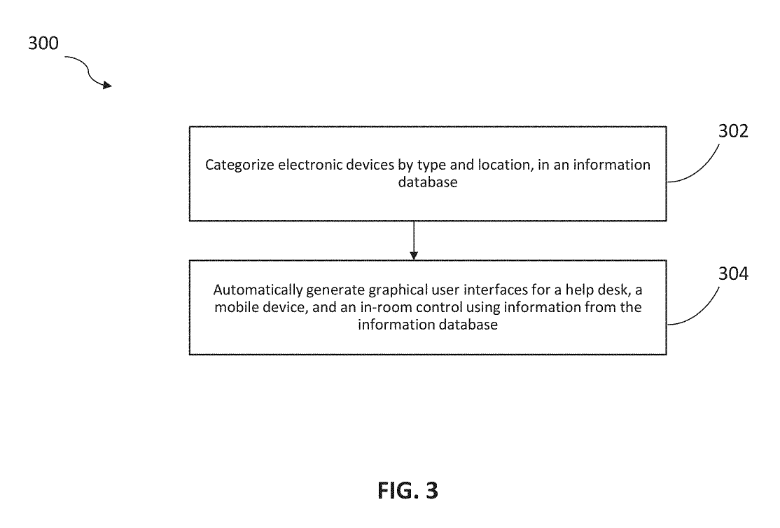

FIG. 3 shows a block diagram of an illustrative method 300 for generating graphical user interfaces for controlling, monitoring and automating a plurality of electronic devices 104 controlled by a control server 102.

In illustrative embodiments, the method 300 includes categorizing by type and location, in an information database, the plurality of electronic devices 104, at step 302. The electronic devices 104 can be located at separate first and second locations 106. The method 300 further includes automatically generating graphical user interfaces for a help desk, a mobile device, and an in-room control panel using information from the infrastructure database, at step 304.

In Illustrative embodiments, the help desk graphical user interface displays live data about device status, such as, but not limited to, video projector lamp usage, rack room temperatures, and/or device failures, while also displaying a map interface that uses a familiar graphical building plan model to provide geographical access to remote room control interfaces as well as device control panels. For example, the map interface of a help desk shows monitored data in real time, and data flags can change color if a value is in an abnormal state (i.e., outside of a predetermined range).

In illustrative embodiments, the help desk interface also includes a dashboard on which users can display data from devices system-wide, facilitating monitoring system status and use. Clicking on a data flag shows real time data about devices and/or room status. Devices can be controlled and/or in-room user interfaces can be accessed to assist users requesting assistance.

In illustrative embodiments, the method 300 comprises generating all control interfaces by simple database configuration, providing consistency in graphical design, minimizing system programming, and providing easing deployment of multiple language versions of the same interfaces.

In illustrative embodiments, a system for generating graphical user interfaces for controlling, monitoring and automating a plurality of electronic devices includes a user experience server that comprises a hardware processor configured to perform the steps of the method 800 for generating graphical user interfaces for controlling, monitoring and automating electronic devices 104 described above.

In illustrative embodiments, a system for generating graphical user interfaces for controlling, monitoring and automating a plurality of electronic devices 104 controlled by a control system 102 comprises a user experience server that includes a hardware processor. The hardware processor is configured to categorize by type and location, in an information database, the electronic devices 104, one of the electronic devices 104 being located at a first location among several locations 106, and another one of the electronic devices 104 being located at a second location 106 that is separate from the first location 106. The hardware processor is further configured to automatically generate graphical user interfaces for a help desk, a mobile device, and an in-room control panel using information from the infrastructure database, dynamically based on information in the information database about at least one of the electronic devices 104 to be controlled by a user and about credentials associated with the user.

In Illustrative embodiments, a user experience server centralizes all control of electronic devices In one company-wide system and provides interfaces for remote help desks to assist users. The help desks can be located be anywhere in the world.

In illustrative embodiments, a user experience server offers an easy-to-learn graphical programming interface and uses standard IT technologies, which allow IT operators to deploy and maintain the system without needing to utilize outside specialized programmers.

In illustrative embodiments, most devices that include a web browser can be used as a control interface. This includes, but is not limited to, smartphones, tablets, smart watches, and personal computers (PCs).

In illustrative embodiments, a user experience server provides user interfaces as web pages, such that, for example, most tablets, smartphones, smart watches, or PCs can be used as a control surface. The pages are responsive and automatically adjust to fit the size of the screen on the device. In-room user interfaces are automatically generated from data in the system's infrastructure database, which describes the equipment in each room. Room control interfaces can be multilingual, and function identically in all languages.

In illustrative embodiments, a user experience server provides user access management with different levels of control granted to different groups of users. Credential management can interface directly with access control mechanisms such as, but not limited to, MICROSOFT ACTIVE DIRECTORY, so that IT administrators can control which users have access to which types of control. In addition, using single sign-on functionalities can eliminate the need for users to remember passwords.

In illustrative embodiments, a user experience server uses existing access control mechanisms such as, but not limited to, MICROSOFT ACTIVE DIRECTORY and Lightweight Directory Access Protocol (LDAP) for user login credentials and access roles management. Every user is given access based on their credentials, regardless of what device they use to access the system.

In illustrative embodiments, communication between a user experience server and connected web browsers is encrypted with a secure protocol, such as, but not limited to, Secure HyperText Transfer Protocol (HTTPS), reducing the risk of a man-in-the-middle attack.

In illustrative embodiments, a user experience server collects real time device status information in one system, such that, for example, the data can be displayed in dashboard widgets such as charts, graphs, and lists. Alarms can be raised when there is an equipment error, when a device needs to be serviced, and/or when a value is outside of its normal range. This can be particularly advantageous, for example, for tracking projector lamp hour usage and/or to determine when an air conditioner is not functioning.

In illustrative embodiments, because data is all being collected in one system, a user experience server is configured to determine how much each device and/or room has been or is being used. For example, if the meeting rooms on the second floor of a building are often booked, but the meeting rooms on the fifth floor are often empty, usage statistics will reveal this trend. Devices can be serviced according to their actual use, not just according to scheduled service.

In illustrative embodiments, a user experience server can be connected to one or several control servers 102, depending on the architecture required or the size of the project. For example, a large venue may utilize one user experience server with one control server 102 to manage all devices in the same building, while a corporation may use one user experience server at its headquarters, connected to several control servers 102 (one in each branch or in each country in which the corporation has a presence) to centrally manage and control several of the corporation's electronic devices worldwide.

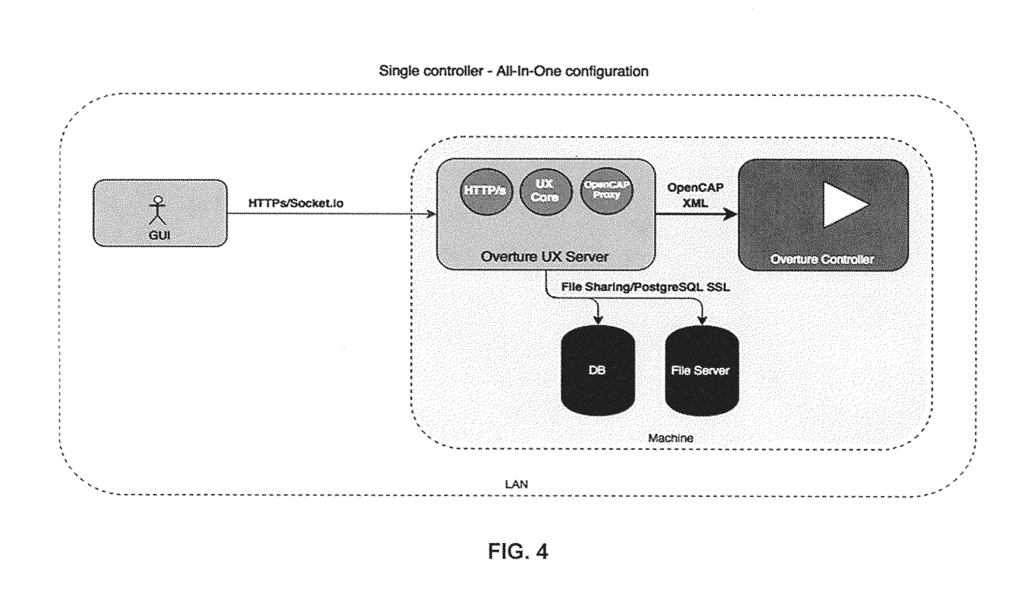

Various illustrative architectures are depicted in FIGS. 4-7. In these figures, the “Overture GUI Server” includes a user experience server, and the “Overture Controller” includes a control server.

FIG. 4 is a block diagram showing an illustrative architecture in which a control server and a user experience server are hosted on the same machine.

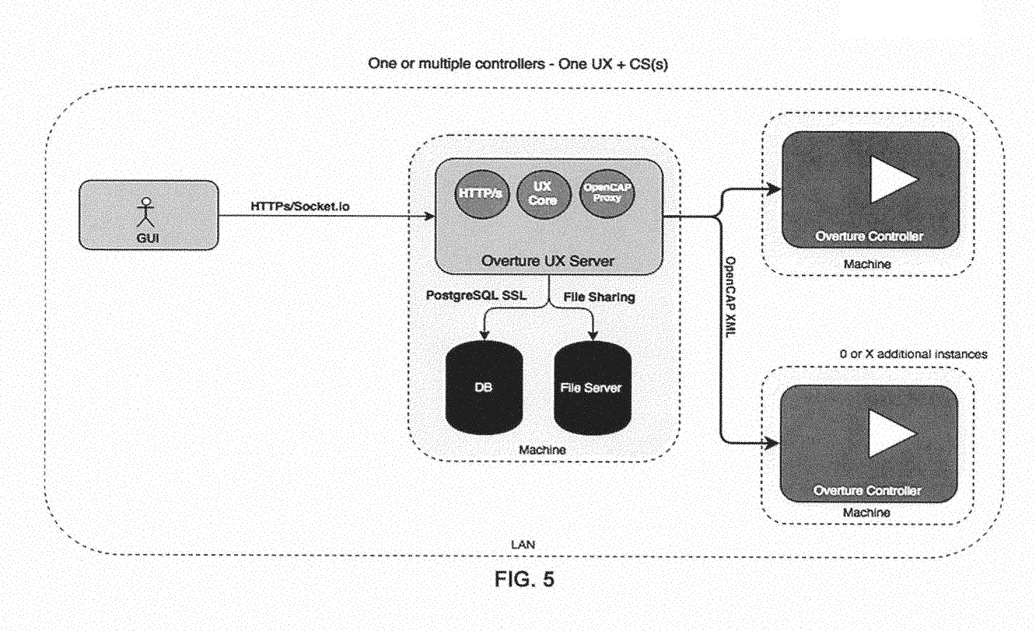

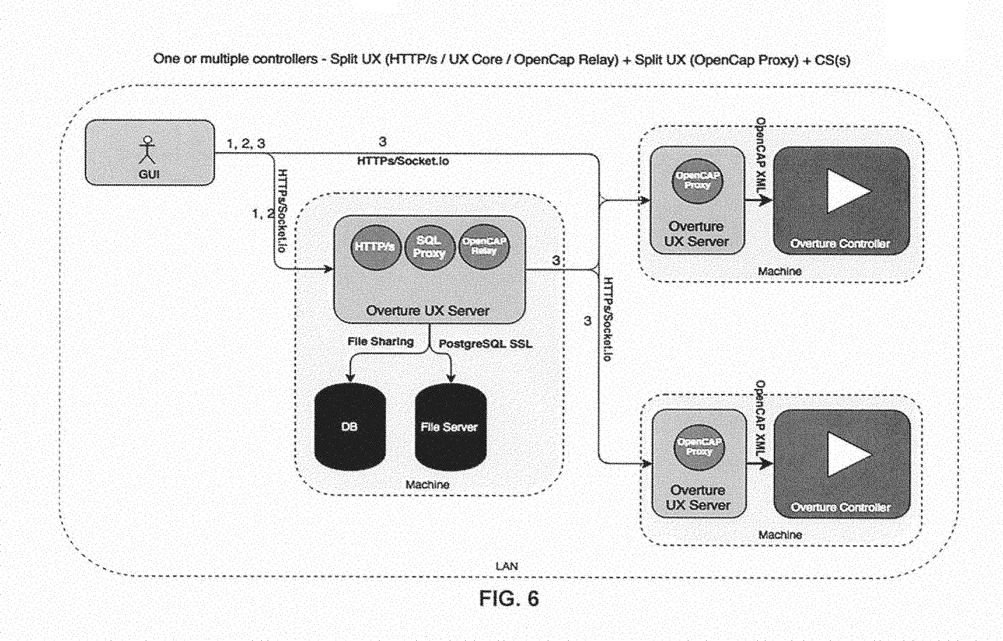

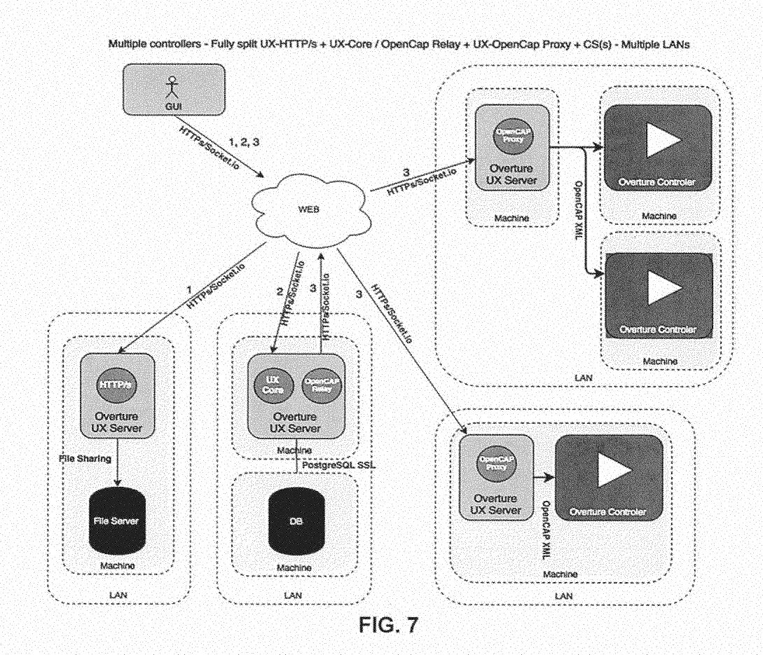

FIG. 5 is a block diagram showing an illustrative, architecture in which several control sealers and one user experience server are on the same local area network (LAN).

FIG. 6 is a block diagram showing an illustrative architecture in which one machine hosts a static HyperText Transfer Protocol (HTTP) service, a Structured Query Language (SQL) Proxy service with a database and a file server, and two other machines each host a control server and a user experience server.

FIG. 7 is a block diagram showing an illustrative architecture in which one machine hosts a static HTTP service and a file server; and another machine hosts an SQL Proxy service with a database. FIG. 7 further shows several machine clusters with various configurations of control servers, user experience servers, and a database. Each cluster of machines is depicted as a different LAN, though Illustrative embodiments can include clusters of machines on a single LAN. Alternatively, one or more of the machine clusters can include their own database, and all databases can be synchronized.

FIG. 8 is a block diagram showing illustrative protocols used between components. In this diagram, “GUI” stands for “graphical user interface.” Protocols depicted include HTTP, HTTPS, the SOCKET.IO library, LDAP, POSTGRESQL, MICROSOFT EXCHANGE WEB SERVICES, OPENCAP XML, and various audiovisual (AV) protocols.

FIG. 9 illustrates a computer system 900 in which embodiments of the present disclosure, or portions thereof, may be implemented as computer-readable code. For example, the control server 102, the room-booking server, the building management system 110, and/or the user experience server may be implemented in a computer system 900 using hardware, software, firmware, non-transitory computer readable media having instructions stored thereon, or a combination thereof and may be implemented in one or more computer systems or other processing systems, Hardware, software, or any combination thereof may embody modules and components used to implement the methods discussed herein.

If programmable logic is used, such logic may execute on a commercially available processing platform or a special purpose device. A person having ordinary skill In the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one hardware processor device and a memory may be used to implement the above described embodiments.

A hardware processor unit or device as discussed herein may be a single hardware processor, a plurality of hardware processors, or combinations thereof. Hardware processor devices may have one or more hardware processor “cores.” The terms “computer program medium,” “non-transitory computer readable medium ”and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant ah how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Hardware processor device 904 may be a special purpose or a general purpose hardware processor device. The hardware processor device 904 may be connected to a communications infrastructure 906, such as a bus, message queue, network, multi-core message-passing scheme, etc. The network maybe any network suitable for performing the functions as disclosed herein and may include a local area network (LAN), a wide area network (WAN), a wireless network (e.g., WiFi), a mobile communication network, a satellite network, the internet, fiber optic, coaxial cable, infrared, radio frequency (RF), or any combination thereof. Other suitable network types and configurations will be apparent to parsons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/Or write to the removable storage unit 918 in a well-known manner. The removable storage unit 918 may include a removable storage media that may be read by and written to by the removable storage drive 914. For example, if the removable storage drive 914 is a floppy disk drive or universal serial bus pert, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge Interface (e.g., as found in video game systems), a removable memory chip (e.g., EEPROM, PROM, etc,) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Illustrative communications interfaces 924 may include a modem, a network interface (e.g., an Ethernet card), a communications pod, a PCMCIA slot and card, etc. Software and data transferred via the communications interface 924 may be in the form of signals, which may be electronic, electromagnetic,, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Illustrative display interfaces 902 may include high-definition multimedia Interlace (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LEO) display, capacitive touch display, thin-film transistor (TPT) display, etc.

Computer program medium and computer usable medium may refer to memories, such as the main memory 903 and secondary memory 910, which may be memory semiconductors (e.g., DRAMs, etc.). These computer program products may be means for providing software to the computer system 900. Computer programs (e.g., computer control logic) may be stored in the main memory 90S and/or the secondary memory 910. Computer programs may also be received via the communications interface 924. Such computer programs, when executed, may enable computer system 900 to implement the present methods as discussed herein. In particular, the computer programs, when executed, may enable hardware processor device 904 to Implement the methods as discussed herein. Accordingly, such computer programs may represent controllers of the computer system 900. Where the present disclosure Is implemented using software, the software may be stored in a computer program product and loaded into the computer system 900 using the removable storage drive 914, interface 920, and bard disk drive 912, or communications interface 924.

While various illustrative embodiments of the disclosed systems and methods have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A system for controlling, monitoring and automating a plurality of electronic devices, the plurality of electronic devices including one or more first electronic devices and one or more second electronic devices, the one or more first electronic devices being located at a first location among a plurality of locations, and the one or more second electronic devices being located at a second location among the plurality of locations, the second location being separate from the first location, the system comprising:
a control server including a hardware processor configured to:
centrally control the plurality of electronic devices;
interface with a room-booking software program, the room-booking software program configured to consider the first and second locations as separate rooms and to create room-booking information relating to the first location;
read the room-booking information relating to the first location;
automatically adjust power and/or a setting of the one or more first electronic devices located at the first location for a scheduled use of the one or more first electronic devices by a user, based on the room-booking information.

2. The system of claim 1, wherein the plurality of locations is a plurality of rooms of one or more buildings, the first location is a first room of the one or more buildings, and the second location is a second room of the one or more buildings.

3. The system of claim 1, wherein the room-booking information includes at least one selected from: information about required types of electronic devices for the scheduled use; a booking schedule of the first location, whether the first location is available for use, a booking schedule of the one or more first electronic devices, whether the one or more first electronic devices is available for use, the power status of the one or more first electronic devices, available settings of the one or more first electronic devices, and current settings of the one or more first electronic devices.

4. The system of claim 1, wherein the room-booking information is stored on at least one selected from: the control server; and a room-booking server separate from the control server and in communication with the control server.

5. The system of claim 1, wherein the hardware processor is configured to automatically configure the one or more first electronic devices prior to a scheduled time for the scheduled use.

6. The system of claim 1, wherein the hardware processor is configured to interface with a building management system to monitor at least one occupancy sensor located at the first location.

7. The system of claim 6, wherein the hardware processor is configured to detect that the scheduled use has ended and/or to detect that the first location is vacant.

8. The system of claim 6, wherein the hardware processor is configured to detect that the scheduled use has not occurred.

9. The system of claim 6, wherein the hardware processor is configured to turn off and/or adjust at least one of the first electronic devices when the hardware processor detects that the first location is vacant.

10. The system of claim 1, wherein the hardware processor is configured to:
determine a power consumption value associated with at least one of the one or more first electronic devices; and
automatically shut down the at least one of the first electronic devices when the power consumption value is greater than a predetermined threshold power consumption value.

11. The system of claim 1, wherein the hardware processor is configured to collect usage information about the plurality of electronic devices.

12. The system of claim 1, wherein the hardware processor is configured to:
determine a usage value associated with at least one of the first electronic devices; and
generate an alert when the power consumption value is greater than a predetermined threshold usage value.

13. The system of claim 1, wherein the room-booking information includes information about required types of electronic devices for the scheduled use, and the hardware processor is configured to:
determine that the one or more second electronic devices located at the second location match the required types of electronic devices; and
automatically transfer the scheduled use from the first location to the second location by automatically adjusting power and/or settings of the one or more second electronic devices located at the second location based on the room-booking information.

14. The system of claim 13, wherein the hardware processor is configured to automatically send a communication to the user notifying the user of the transfer to the second location.

15. The system of claim 1, wherein the room-booking information includes information about required types of electronic devices for the scheduled use, the plurality of electronic devices further includes one or more third electronic devices located at a third location among the plurality of locations, and the hardware processor is configured to:
determine that the one or more second electronic devices located at the second location (i) do not match the required types of electronic devices and/or (ii) are unusable for the scheduled use;
determine that the one or more third electronic devices located at the third location match the required types of electronic devices; and
automatically transfer the scheduled use from the first location to the third location by automatically adjusting power and/or settings of the one or more third electronic devices located at the third location based on the room-booking information.

16. A method for controlling, monitoring and automating a plurality of electronic devices, the plurality of electronic devices including one or more first electronic devices and one or more second electronic devices, the one or more first electronic devices being located at a first location among a plurality of locations, and the one or more second electronic devices being located at a second location among the plurality of locations, the second location being separate from the first location, the method comprising:
obtaining central control of the plurality of electronic devices;
interfacing with a room-booking software program, the room-booking software program configured to consider the first and second locations as separate rooms and to create room-booking information relating to the first location;
reading the room-booking information relating to the first location;
automatically adjusting power and/or a setting of the one or more first electronic devices located at the first location for a scheduled use of the one or more first electronic devices by a user, based on the room-booking information.

17. The method of claim 16, wherein the automatically configuring of the one or more first electronic devices is performed prior to a scheduled time for the scheduled use.

18. The method of claim 16, comprising interfacing with a building management system to monitor at least one occupancy sensor located at the first location.

19. The method of claim 18, comprising turning off and/or adjusting at least one of the one or more first electronic devices when detecting that the first location is vacant.

20. A system for generating graphical user interfaces for controlling, monitoring and automating a plurality of electronic devices centrally controlled by a control server, the plurality of electronic devices including one or more first electronic devices and one or more second electronic devices, the one or more first electronic devices being located at a first location among a plurality of locations, and the one or more second electronic devices being located at a second location among the plurality of locations, the second location being separate from the first location, the system comprising:
a user experience server including a hardware processor configured to:
categorize by type and location, in an information database, the plurality of electronic devices; and
automatically generate graphical user interfaces for a help desk, a mobile device, and an in-room control panel using information from the information database, dynamically based on information in the information database about at least one of the first and second electronic devices to be controlled by a user and about credentials associated with the user.

21. The system of claim 1, wherein the one or more first electronic devices and the one or more second electronic devices include at least one selected from a projector and a display.

22. The system of claim 1, wherein the first location is located in a first building and the second location is located in a second building which is spaced from the first building.
